(19) United States
(12) Patent Application Publication
(10) Pub. No.: US 2014/0006219 A1
(43) Pub. Date: Jan. 2, 2014

(54) COUNTEROFFER GENERATION SERVICE

(71) Applicants: Rita H. Wouhaybi, Portland, OR (US); Hong Li, El Dorado Hills, CA (US); Stanley Mo, Portland, OR (US); Mubashir A. Mian, Santa Clara, CA (US); Tobias M. Kohlenberg, Portland, OR (US)

(72) Inventors: Rita H. Wouhaybi, Portland, OR (US); Hong Li, El Dorado Hills, CA (US); Stanley Mo, Portland, OR (US); Mubashir A. Mian, Santa Clara, CA (US); Tobias M. Kohlenberg, Portland, OR (US)

(21) Appl. No.: 13/538,087

(22) Filed: Jun. 29, 2012

(51) Int. Cl. G06Q 30/06

(52) U.S. Cl. 705/27.1; 705/26.1

(57) ABSTRACT

Systems and methods may provide for implementing a counteroffer generation service. In one example, the method may include detecting an inquiry relating to an item offered by a vendor, analyzing the inquiry to determine the item, generating a counteroffer relating to the item, generating counteroffer code including the counteroffer relating to the item, and conducting a transaction relating to the item utilizing the counteroffer code.

### BACKGROUND

Embodiments generally relate to counteroffer generation services. More particularly, embodiments relate to a counteroffer generation service that may include generating a counteroffer for an item of interest for a customer shopping locally at a vendor site.

Price comparison applications may allow a customer to compare a price offered by a brick-and-mortar (BM) vendor to those offered by vendors online. Typically, the BM vendor may be unaware that the consumer is shopping for a better offer, and has no way of providing the customer with a counteroffer.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a networking architecture that implements a counteroffer generation service in accordance with an embodiment of the invention;

FIG. 2 is a block diagram of an example of a cloud that implements a counteroffer generation service in accordance with an embodiment of the invention;

FIG. 3 is a block diagram of an example of a vendor system that implements a counteroffer generation service in accordance with an embodiment of the invention;

FIG. 4 is a block diagram of an example of a customer device that implements a counteroffer generation service in accordance with an embodiment of the invention;

FIG. 5 is a block diagram of an example of a customer interface station that implements a counteroffer generation service in accordance with an embodiment of the invention;

FIG. 6 is a block diagram of an example of a vendor payment station that implements a counteroffer generation service in accordance with an embodiment of the invention;

FIG. 7 is a flowchart of an example of a method of implementing a counteroffer generation service in accordance with an embodiment of the invention;

FIG. 8 is a block diagram of an example of a logic architecture according to an embodiment;

FIG. 9 is a block diagram of an example of a processor according to an embodiment; and

FIG. 10 is a block diagram of an example of a system according to an embodiment.

### DETAILED DESCRIPTION

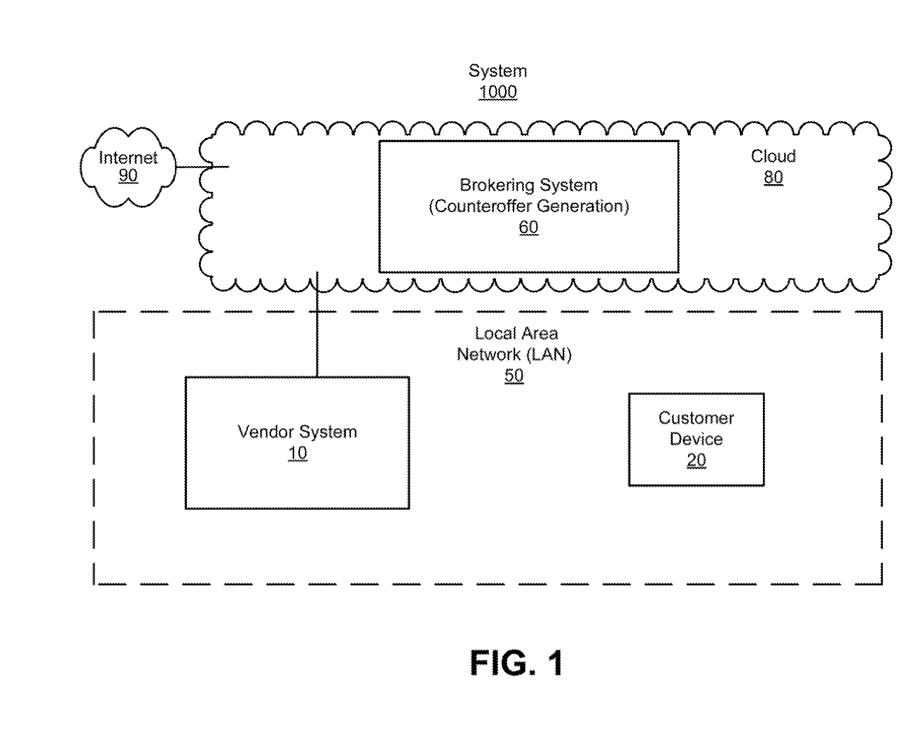

Turning now to FIG. 1, a block diagram of a networking architecture 1000 that implements a counteroffer generation service is shown. The networking architecture 1000 may include a vendor system 10 and a customer device 20, which may communicate via, among other things, a local area network (LAN) 50. The networking architecture 1000 may also include a brokering (e.g., third party offer generation) system 60, which may reside in a cloud 80. The vendor system 10, the customer device 20, the brokering system 60, and the cloud 80 may be coupled to the Internet 90.

As will be discussed in greater detail, in one example, the vendor system 10 and the LAN 50 may be operated by a vendor that offers an item (e.g., product and/or service) for sale at the vendor's BM site (e.g., in-store offer). The vendor system 10 may generally be configured to detect customer inquiries regarding in-store offers while customers are shopping at the BM site. More particularly, the illustrated vendor system 10 determines when a customer uses either the customer device 20 or the vendor system 10 to search online for offers that are better, from the customer's perspective, than the in-store offer. So, for example, if the customer uses a price comparison application to compare prices offered by online vendors, the vendor system 10 may be configured to detect this inquiry, and analyze the inquiry to identify the item in question.

At this point, the vendor system 10 may be configured to communicate with the brokering system 60 to request that the brokering system 60 generate a counteroffer relating to the item. The brokering system 60 may be operated by a third party (i.e., a party other than the vendor or a customer). The request communication may include, for example, the price comparisons retrieved by the price comparison application. Upon receiving this request, the brokering system 60 may generate a counteroffer, and transmit it back to the vendor system 10 for presentation to the customer. The counteroffer may therefore be considered a “counter” to the customer's activity in searching elsewhere for better deals. The brokering system 60 may also be configured to directly detect in-store inquiries from customers at the BM site and report the inquiries to the vendor system 10. The brokering system 60 may also provide counteroffer information along with the reported in-store inquiry information.

The sequence and numbering of blocks depicted in FIG. 1 is not intended to imply an order of operations to the exclusion of other possibilities. Those of skill in the art will appreciate that the foregoing systems and methods are susceptible of various modifications, variations, and alterations.

For example, in the example described in FIG. 1, the brokering system 60 may be operated by a third party. However, this need not necessarily be the case. In another example, the brokering system 60 may be operated by, for example, the vendor operating the BM site. In the case of a third party operating the brokering system 60, a user may not need to disclose certain information (e.g., shopping transaction histories, personal information, etc.) to the vendor to generate a counteroffer. In addition, in the case of a third party operating the brokering system 60, the user may be able to utilize the brokering system 60 with respect to more than one vendor.

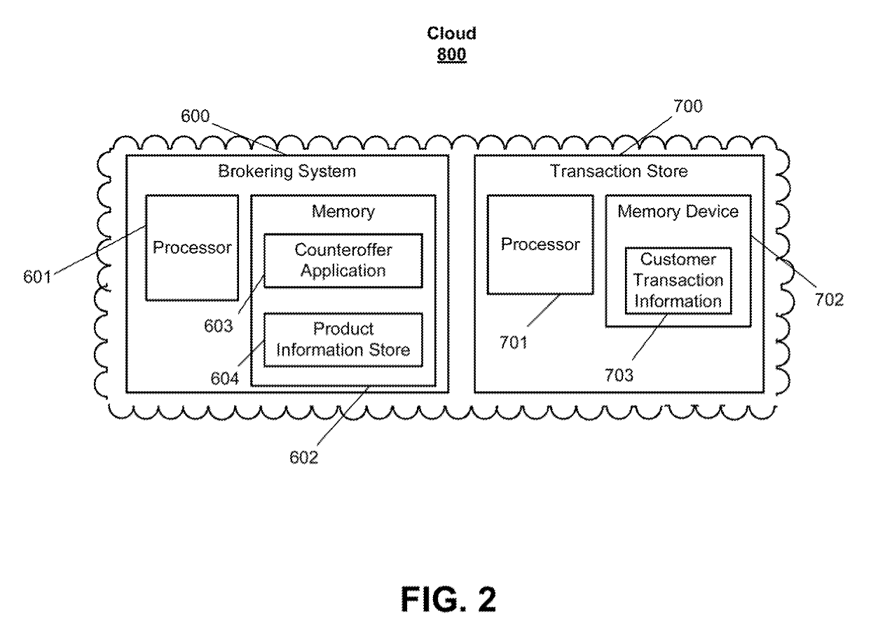

Turning now to FIG. 2, a block diagram of a cloud 800, similar to the cloud 80 (FIG. 1) is shown. In this example, the cloud 800 may include a brokering system 600, similar to the brokering system 60 (FIG. 1), and a transaction store 700.

The brokering system 600 may be any programmable machine that may carry out a sequence of logical operations. In this example, the brokering system 600 may be a computer server system operated by a third party, and may be configured to facilitate a counteroffer generation service. The brokering system 600 may include a processing component 601 and a memory device 602.

The processing component 601 may include at least one computer processor that may be utilized to execute computer-readable executable instructions. For example, as will be discussed in greater detail, the processing component 601 may be configured to execute various software applications relating to a counteroffer generation service.

The memory device 602 may be any device configured to store data. In this case, the memory device 602 may include a counteroffer application (e.g., third party counteroffer generation application) 603 and product information store 604.

The counteroffer application 603 may be configured to implement a counteroffer generation service on behalf of a vendor operating a BM site. As discussed above, a vendor (via a vendor system) and/or the brokering system 600 may detect a customer inquiry relating to an item of interest. The vendor may then request that the brokering system 600 generate a counteroffer relating to the item of interest for the customer.

In doing so, the counteroffer application 603 may access the product information store 604. The product information store 604 may include any information related to an item of interest to a user. Examples of information related to an item of interest to a user may include product information, related products, services, pricing information, and warranty information. So, in one example, in generating a counteroffer for a particular item of interest, the counteroffer application 603 may access warranty information located in the product information store 604. If appropriate, the counteroffer application 603 may generate a counteroffer offering ten percent off the vendor's BM store price along with a six-month warranty.

The transaction store 700 may be any programmable machine that may carry out a sequence of logical operations. In this example, the transaction store 700 may be a computer server system configured to facilitate a counteroffer generation service, and may include, among other things, a processing component 701 and a memory device 702.

The processing component 701 may include at least one computer processor that may be utilized to execute computer-readable executable instructions. For example, as will be discussed in greater detail, the processing component 701 may be configured to execute various software applications relating to a counteroffer generation service.

The memory device 702 may be any device configured to store data. In this case, the memory device 702 may store, among other things, customer transaction information 703.

The customer transaction information 703 may include any information relating to any transaction conducted by a customer. Examples of the customer transaction information 703 may include, among other things, a customer profile (e.g., name, address, age, etc.), customer loyalty information (e.g., rewards points) and customer transaction information (e.g., receipts). As will be discussed in greater detail, a counteroffer generation application (e.g., the counteroffer application 603) may refer to the customer transaction information 703 to generate a counteroffer for a customer. So, for example, in generating a counteroffer for a customer, the counteroffer application 603 may access the customer transaction information 703 to determine that the customer has accumulated a significant amount of loyalty points with the vendor. As such, the counteroffer application 603 may, if appropriate, generate a counteroffer that includes redemption of some of the customer's loyalty points.

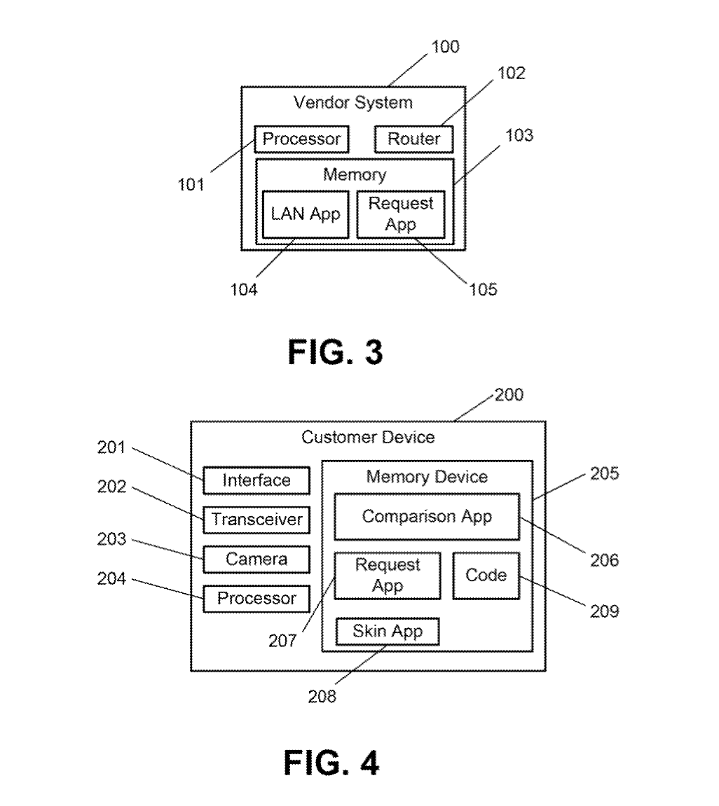

Turning now to FIG. 3, a block diagram of a vendor system 100, similar to the vendor system 10 (FIG. 1) is shown. The vendor system 100 may be any programmable machine that may carry out a sequence of logical operations. In this example, the vendor system 100 may be a computer system configured to facilitate a generation of counteroffer to a customer shopping at a vendor's BM site in response to an in-store inquiry by the customer. The vendor system 100 may include a processing component 101, a wireless router 102, and a memory device 103.

The processing component 101 may include at least one computer processor that may be utilized to execute computer-readable executable instructions. For example, as will be discussed in greater detail, the processing component 101 may be configured to execute various software applications relating to a counteroffer generation service.

The wireless router 102 may be a device that performs one or more functions of a router, a wireless access point, and a network switch. In this example, the wireless router 102 may host a LAN, such as the LAN 50 (FIG. 1), and may facilitate communication via a wireless data connection (e.g., IEEE 802.11, 1999 Edition, LAN/MAN Wireless LANS (Wi-Fi), IEEE 802.16-2004, LAN/MAN Broadband Wireless LANS (WiMAX)). In another embodiment, the wireless router 102 may be configured to facilitate a network via a different communication protocol.

The memory device 103 may be any device configured to store data. In this case, the computing device memory device 103 may store, among other things, a LAN application 104 and a counteroffer request application 105.

The LAN application 104 may be configured to administer a LAN, such as the LAN 50 (FIG. 1). For example, as will be discussed in greater detail below, the LAN application 104 may be configured to detect a customer's use of a price comparison application. So, in one example, if a customer uses a price comparison application to compare prices offered by online vendors for an item of interest, the LAN application 104 may, among other things, parse the request communication to detect that the customer is seeking a price comparison, and identify the item of interest.

The counteroffer request application 105 may be an application configured to, among other things, request generation of counteroffer. So, for example, upon detection (e.g., by the LAN application 104) of the price comparison request submitted by the customer, the counteroffer request application 105 may, among other things, transmit a request to a counteroffer generation system, such as the brokering system 60 (FIG. 1), to initiate generation of counteroffer for the customer.

Turning now to FIG. 4, a block diagram of a customer device 200, similar to the customer device 20 (FIG. 1) is shown. The customer device 200 may be any programmable machine that may carry out a sequence of logical operations. Examples of the customer device 200 may include a laptop, desktop, personal digital assistant (PDA), media player, a mobile Internet device (MID), any smart device such as a smart phone, smart tablet, smart TV, or the like. In this example, the customer device 200 may be a smart phone. The customer device 200 may include an interface 201, a transceiver 202, a camera 203, a processor 204, and a memory device 205.

The interface 201 may be a component configured to allow a customer to interact with the customer device 200. For example, in this embodiment, the interface 201 may be a smart phone screen utilizing a graphical user interface (GUI).

The transceiver 202 may be a transmitter/receiver that enables the customer device 200 to wirelessly communicate with other devices. In this example, the transceiver 202 may be configured to communicate via a Wi-Fi connection. The transceiver 202 may also communicate via near-field communication protocol, Bluetooth (e.g., IEEE 802.15.1-2005, Wireless Personal Area Networks), Zigbee (IEEE 802.15.4), etc.), a cellular telephone connection (e.g., W-CDMA (UMTS), CDMA2000 (IS-856/IS-2000), etc.), a wired data connection (e.g., RS-232 (Electronic Industries Alliance/EIA), Ethernet (e.g., IEEE 802.3-2005, LAN/MAN CSMA/CD Access Method), power line communication (e.g., X10, IEEE P1675), USB (e.g., Universal Serial Bus 2.0 Specification)), etc., depending upon the circumstances.

The camera 203 may be any device configured to capture an image or a video feed of an object. For example, the camera 203 may be configured to capture an image of a universal product code (UPC) of an item of interest to the user.

The processing component 204 may include at least one computer processor that may be utilized to execute computer-readable executable instructions. For example, as will be discussed in greater detail, the processing component 204 may be configured to execute various software applications relating to a counteroffer generation service.

The memory device 205 may be any device configured to store data. In this case, the memory device 205 may store, among other things, a comparison application 206, a customer counteroffer request application 207, a skin application 208, and counteroffer code 210.

The comparison application 206 may be an application configured to compare prices offered by online vendors. In one example, the customer may capture an image (or video) of a UPC of an item of interest (e.g., using the camera 203) offered by a BM vendor. The comparison application 206 may then analyze the image to extract the UPC of the item of interest, transmit a request communication requesting price comparisons, and receive a result communication including prices offered by online vendors.

The customer counteroffer request application 207 may be configured to facilitate a generation of a counteroffer for a customer shopping at a vendor's BM site. For example, the customer may use the customer counteroffer request application 207 to request that a counteroffer generation system, such as the brokering system 60 (FIG. 1), generate a counteroffer relating to an item of interest to the customer. Also, as will be discussed in greater detail, the customer counteroffer request application 207 may be configured to delete an invalid counteroffer code from the memory device 205. The customer may, for example, download the Customer counteroffer request application 207 from a vendor website prior to entering the vendor's BM site to enhance her shopping experience with vendor.

The skin application 208 may be an application that may be utilized in conjunction with the comparison application 206 to facilitate a counteroffer service offered by the BM vendor. For example, when the user initiates the comparison application 206, the skin application 208 may be configured to transmit a request (e.g., to the brokering system 60 (FIG. 1)) to generate a counteroffer for the user. Moreover, the skin application 208 may be configured to list the counteroffer along with results returned from the comparison application 206. The customer may, for example, download the skin application 208 from a vendor website prior to entering the vendor's BM site to enhance her shopping experience with vendor.

The counteroffer code 209 may be an electronic data file representing a counteroffer. For example, the counteroffer code 209 may be generated for the customer by a brokering system, such as the counteroffer generation system 60 (FIG. 1), and may pertain to one or more items of interest. As will be discussed in greater detail, the brokering system may transmit the counteroffer code 209 to the customer, who may then present the counteroffer code 209 to the vendor to redeem the counteroffer. In this example, the counteroffer code 209 may take the form of a quick response (QR) code. In another example, the counteroffer code 209 may take the form of a barcode.

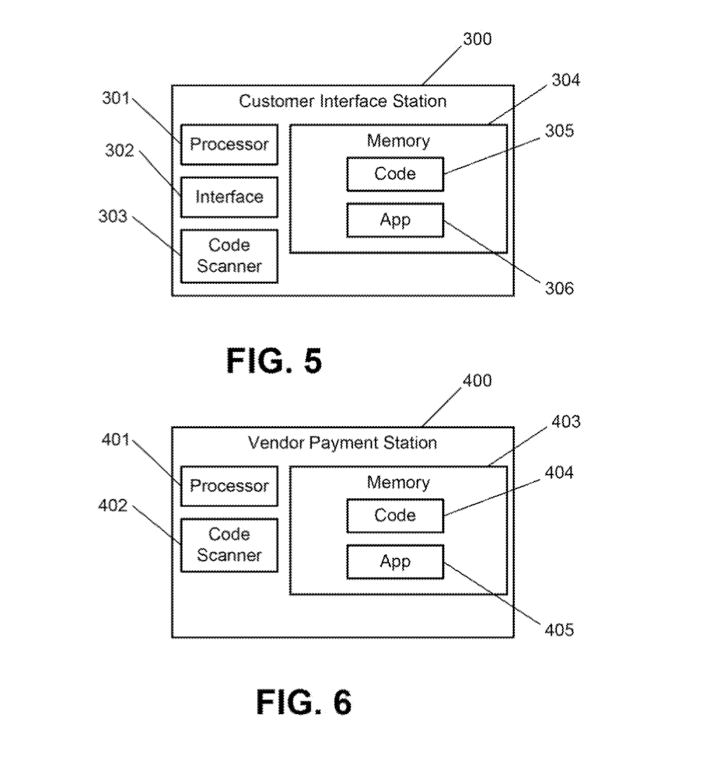

Turning now to FIG. 5, a block diagram of a customer interface station 300 is shown. In one example, the customer interface station 300 may be coupled to a vendor system, such as the vendor system 10 (FIG. 1). As will be discussed in greater detail, the customer interface station 300 may be a device configured to interface with the customer to, among other things, provide information relating to items offered by the vendor. So, for example, upon receipt of a counteroffer code, such as the counteroffer code 209 (FIG. 4), from a counteroffer generation system, such as the brokering system 60 (FIG. 1), a customer may present the counteroffer code to the customer interface device 300 to, among other things, provide information relating to the generated counteroffer (e.g., terms, conditions, etc.).

The customer interface station 300 may be any programmable machine that may carry out a sequence of logical operations. In this example, the customer interface station 300 may be kiosk located at the end of a shopping aisle in the vendor's BM store. In this example, the customer interface station 300 may include a processing component 301, an interface 302, a counteroffer code scanner 303, and a memory 304.

The processing component 301 may include at least one computer processor that may be utilized to execute computer-readable executable instructions. For example, as will be discussed in greater detail, the processing component 301 may be configured to execute various software applications relating to a counteroffer generation service.

The interface 302 may be a component configured to allow a user to interact with the customer interface station 300. In this example, the interface 302 may be a kiosk screen including a graphical user interface (GUI).

The counteroffer code scanner 303 may be a component configured to capture an image file of a counteroffer code displayed by a customer device. In this example, the counteroffer code scanner may be a camera device. In another example, the counteroffer code scanner may be an infrared (IR) scanner.

The memory device 304 may be any device configured to store data. The computing device memory device 304 may include a customer interface station counteroffer code 305 and a customer interface application 306. The customer interface station counteroffer code 305 may be an electronic data file representing a counteroffer. The customer interface application 306 may be configured to facilitate a counteroffer generation service for a customer shopping at a vendor's BM site.

So, for example, the counteroffer code scanner 303 may generate the customer interface station counteroffer code 305 by capturing a counteroffer code, such as the counteroffer code 209 (FIG. 4), displayed on a customer device, such as the customer device 200 (FIG. 4). The customer interface device application 306 may then analyze the customer interface station counteroffer code 305 to extract the counteroffer, and display the terms of the counteroffer on the interface 302 for the customer.

Turning now to FIG. 6, a block diagram of a vendor payment station 400 is shown. The vendor payment station 400 may be any programmable machine that may carry out a sequence of logical operations. As will be discussed in greater detail below, the vendor payment station 400 may be a device operated by the BM vendor, and may be configured to, among other things, facilitate a payment from a customer.

So, for example, upon receipt of a counteroffer code, such as the counteroffer code 209 (FIG. 4) from a brokering system, such as the brokering system 60 (FIG. 1), a customer may present the counteroffer code to the vendor payment station 400 to, among other things, conduct a payment transaction for an item of interest. The vendor payment station 400 may include a processing component 401, counteroffer code scanner 402, and a memory device 403.

The processing component 401 may include at least one computer processor that may be utilized to execute computer-readable executable instructions. For example, as will be discussed in greater detail, the processing component 401 may be configured to execute various software applications relating to a counteroffer generation service.

The counteroffer code scanner 402 may be a component configured to capture an image file of a counteroffer code displayed by a customer device. In this example, the counteroffer code scanner may be a camera device. In another example, the counteroffer code scanner may be an infrared (IR) scanner.

The memory device 403 may be any device configured to store data. In this case, the memory device 403 may include: a vendor payment device counteroffer code 404 and a vendor payment device application 405. The vendor payment device counteroffer code 404 may be an electronic data file representing a counteroffer. The vendor payment device application 405 may be configured to facilitate a counteroffer generation service for a customer shopping at a vendor's BM site.

So, for example, the counteroffer code scanner 402 may generate the vendor payment device counteroffer code 404 by capturing a counteroffer code, such as the counteroffer code 209 (FIG. 4), displayed on a customer device, such as the customer device 200 (FIG. 4). The vendor payment device application 405 may then analyze the vendor payment device counteroffer code 404 to extract the counteroffer, and facilitate a payment transaction at the vendor payment station 400 in accordance with the terms of the counteroffer.

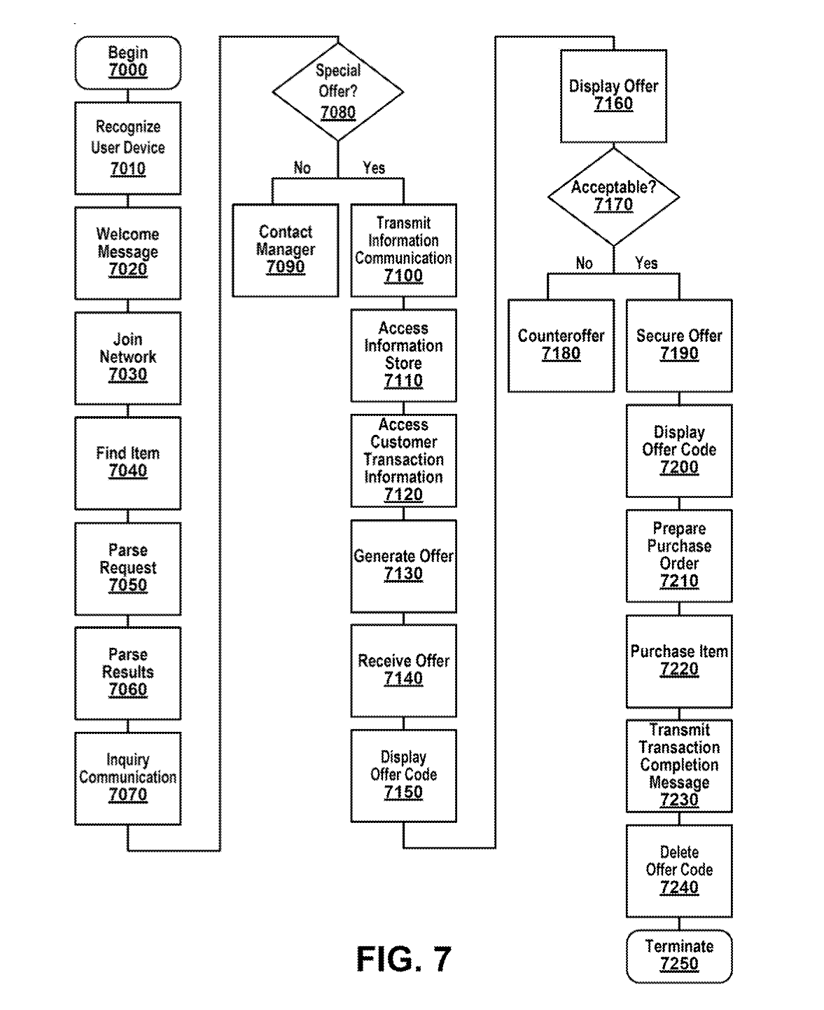

Turning now to FIG. 7, a flowchart of an example of a method of implementing a counteroffer generation service in accordance with an embodiment of the invention is shown. In this example, a repeat customer, utilizing a customer device, such as the customer device 20 (FIG. 1), may enter a BM site operated by a vendor to purchase an item. The customer device may include a customer counteroffer request application, such as the customer counteroffer request application 207 (FIG. 1).

The method might be implemented as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method may be written in any combination of one or more programming languages, including an object oriented programming language such as Java, Smalltalk, C++ or the like and conventional procedural programming languages, such as the “C” programming language or similar programming languages.

The process may begin at processing block 7000. At processing block 7010, a Wi-Fi network operated by the vendor, such as the vendor LAN 50 (FIG. 1), may recognize the customer's user device upon the customer's entry to the BM store. The Wi-Fi network may be hosted by a vendor system, such as the vendor system 10 (FIG. 1).

At processing block 7020, the customer may receive a welcome message at the customer device to connect to the Wi-Fi network. At processing block 7030, the customer may join the Wi-Fi network.

At processing block 7040, the customer may find an item of interest, and may use a comparison application, such as the comparison application 206 (FIG. 4), to compare prices available online. At processing block 7050, a LAN application, such as the LAN application 104 (FIG. 1), may parse a comparison application request communication to detect price comparison request and identify the item. At processing block 7060, a counteroffer request application, such as the counteroffer request application 105 (FIG. 3), may parse a result communication to analyze the counteroffers retrieved. For example, the first counteroffer application may analyze the retrieved offers to determine their legitimacy.

At processing block 7070, the counteroffer request application may transmit an inquiry communication to the customer device for display. At processing block 7080, the displayed inquiry communication may inquire whether the customer would like to receive a special offer from the BM vendor regarding the item of interest. If the customer indicates she does not, then at processing block 7090, the message may encourage the customer to speak to the manager of the BM site to, for example, receive a special offer.

On the other hand, if the customer agrees, then at processing block 7100, the counteroffer request application may transmit a communication to a brokering system application, such as the counteroffer application 603 (FIG. 2), located at a brokering system, such as the brokering system 60 (FIG. 1), to determine whether to prepare counteroffer for the customer and, if appropriate, generate a counteroffer. The communication may include, among other things, the location of the BM store (e.g., using global position system (GPS) data), the identity of the customer's user device, the identity of the item of interest to the customer, and the counteroffers retrieved by the customer's price comparison application.

At processing block 7110, upon receiving the communication, the counteroffer application may access a product information store, such as the product information store 604 (FIG. 2), to retrieve any information that may be relevant to generating counteroffer for the customer. In this example, the counteroffer application may retrieve product information, related products, pricing information, and warranty information.

At processing block 7120, the counteroffer application may access the customer's customer transaction information, such as the customer transaction information 703 (FIG. 2), located at a transaction store, such as the transaction store 700 (FIG. 2), to retrieve any available information that may be relevant to generating a counteroffer for the customer. In this example, the counteroffer application may retrieve the customer's profile, loyalty information, and (prior) transaction information.

At processing block 7130, the counteroffer application may use the accumulated information to generate a counteroffer relating to the item of interest to the customer, and transmit the counteroffer to the customer. In this example, the vendor may match the lowest price retrieved by the comparison application.

In another example, if unable to match the price the lowest price retrieved by the comparison application, the counteroffer application may generate a different offer instead. For example, the counteroffer application may analyze the information found in the transaction store to recognize that the customer has accumulated a significant amount of loyalty points with the vendor. As such, the counteroffer application may generate counteroffer for a better quality product for the same price, in addition to redemption of some of the customer's loyalty points.

At processing block 7140, the customer may receive the counteroffer at the customer device. In this example, the counteroffer may be included in a secure message (e.g., encrypted) sent from the brokering system. The secure message may include counteroffer code, such as the counteroffer code 209 (FIG. 4). In this example, the counteroffer code may be an encrypted QR code. In order to view the counteroffer, the secure message may request that the customer to display the counteroffer code at the nearest customer interface station, such as the customer interface station 300 (FIG. 5).

In addition, the message may instruct the customer that the counteroffer is conditionally valid. In this example, the counteroffer may expire after a period of time (e.g., ten minutes), and may be expire if the customer leaves the store location. If the period were to expire, or the customer were to leave the store, the customer device counteroffer application may be configured to delete the counteroffer code from a customer device memory, such as the memory 205 (FIG. 1).

At processing block 7150, the customer may display the counteroffer code at the customer interface station, which may read the counteroffer code using counteroffer code scanner, such as the counteroffer code scanner 303 (FIG. 5). At processing block 7160, a customer interface station application, such as the customer interface station application 306 (FIG. 1), may extract the counteroffer (i.e., the counteroffer matching the lowest price retrieved by comparison application), and display it on a display screen, such as the interface 302 (FIG. 1).

At processing block 7170, the customer interface station application may inquire whether the counteroffer is acceptable to the customer. If the counteroffer is not acceptable, then at processing block 7180, the customer interface station application may attempt to modify the counteroffer. For example, the customer interface station application may inquire whether the customer is interested in any other products (e.g., a item related to the item of interest) or services (e.g., a warranty, a maintenance plan, etc.) offered by the vendor. The customer may indicate, via the customer interface station, that she is interested in a maintenance plan. In this case, the counteroffer application may generate counteroffer that may offer the item at the listed price, but may offer one year of free maintenance in addition.

If, on the other the hand, the counteroffer is acceptable, then at processing block 7190, the customer interface station application may provide instructions to the customer regarding how to secure the counteroffer. Specifically, the customer interface station application may request that the customer display the counteroffer code at a vendor payment station, such as the vendor payment station 400 (FIG. 1), to complete a purchase transaction.

At processing block 7200, the customer may display the counteroffer code at the vendor payment station, which may read the counteroffer code using a counteroffer code scanner, such as the counteroffer code scanner 402 (FIG. 1). At processing block 7210, a vendor payment device application, such as the vendor payment device application 405 (FIG. 1), may extract the counteroffer (i.e., the counteroffer matching the lowest price retrieved by comparison application), and prepare a purchase order according to its terms. At processing block 7220, the customer may purchase the item.

At processing block 7230, the vendor payment device application may transmit a transaction completion message to the customer device, the transaction store, and the vendor system. The transaction completion message may include a receipt detailing information relating to the purchase of the item, which may be stored in the customer transaction information. Also, the receipt may be used to update the customer's loyalty points for future access by the brokering system. Furthermore, the vendor system may use the receipt to update inventory at the vendor's BM store.

At processing block 7240, the customer counteroffer request application may delete the counteroffer code from the customer device. At processing block 7250, the process may terminate.

The sequence and numbering of blocks depicted in FIG. 7 is not intended to imply an order of operations to the exclusion of other possibilities. Those of skill in the art will appreciate that the foregoing systems and methods are susceptible of various modifications, variations, and alterations.

For example, in the embodiment illustrated in FIG. 7, the counteroffer generation service may be configured to generate counteroffer to a customer with respect to one vendor offering an item of interest. However, in other embodiments, a counteroffer generation service may be configured to consider more than one vendor while generating counteroffer. So, for example, if counteroffer is to be generated for a customer shopping for an item of interest at a first vendor's BM site, a counteroffer application may be configured to generate counteroffer that may offer loyalty points that may be redeemed with respect a second vendor.

Also, for example, in the embodiment illustrated in FIG. 7, a counteroffer application of the counteroffer generation service may use the results of a price comparison application requested by a customer to generate counteroffer for an item of interest (i.e., processing block 7130). However, this need not necessarily be the case. In another embodiment, if appropriate, the counteroffer application may itself conduct a price comparison amongst competing vendors before generating a counteroffer for the customer.

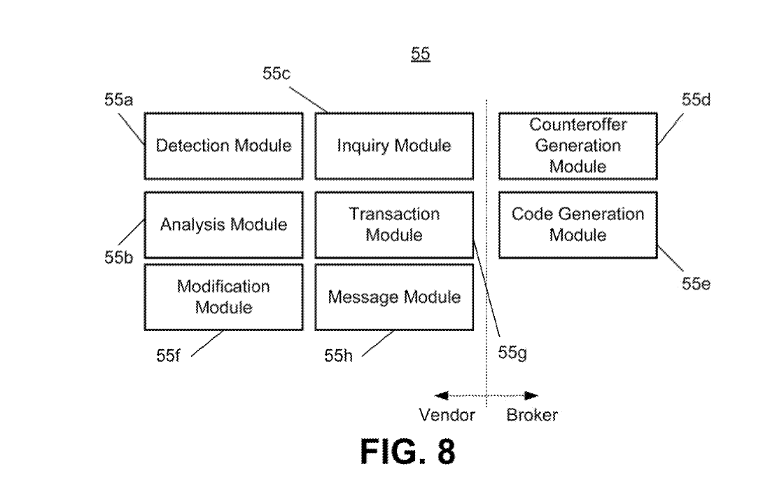

FIG. 8 shows a logic architecture 55 (55a-55h) according to one embodiment. In the illustrated example, a vendor portion of the logic architecture 55 includes a detection module 55a to detect an in-store inquiry relating to an item offered by the vendor and an analysis module 55b to analyze the in-store inquiry and identify the item. An inquiry module 55c may inquire if the customer would like a counteroffer relating to the item, wherein a request may be generated if an affirmative response is received from the customer. A counteroffer generation module 55d in a broker portion of the architecture 55 may generate a counteroffer in response to the request, wherein a counteroffer code generation module 55e may generate a counteroffer code that includes the counteroffer and transmit the counteroffer code to a customer device. In the illustrated example, the vendor portion of the architecture 55 also includes a counteroffer modification module 55f to modify the counteroffer, a transaction module 55g to conduct a transaction relating to the item based on the counteroffer code, and a message module 55h to output a transaction completion message that includes a receipt for the transaction. The brokering portion of the architecture may also include detection and analysis modules to detect and analyze in-store inquiries in order to determine an appropriate counteroffer to present to the customer.

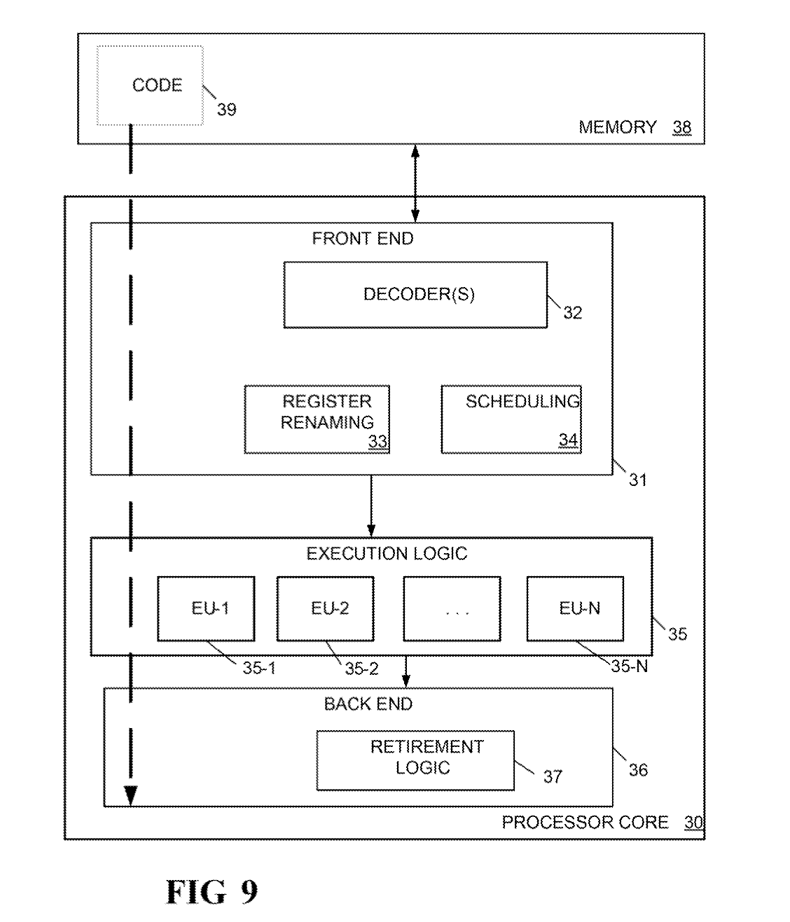

FIG. 9 illustrates a processor core 30 according to one embodiment. The processor core 30 may be the core for any type of processor, such as a micro-processor, an embedded processor, a digital signal processor (DSP), a network processor, or other device to execute code. Although only one processor core 30 is illustrated in FIG. 9, a processing element may alternatively include more than one of the processor core 30 illustrated in FIG. 9. The processor core 30 may be a single-threaded core or, for at least one embodiment, the processor core 30 may be multithreaded in that it may include more than one hardware thread context (or “logical processor”) per core.

FIG. 9 also illustrates a memory 38 coupled to the processor 30. The memory 38 may be any of a wide variety of memories (including various layers of memory hierarchy) as are known or otherwise available to those of skill in the art. The memory 38 may include one or more code 39 instruction(s) to be executed by the processor 30 core, wherein the code 39 may implement the logic architecture 50 (FIG. 8), already discussed. The processor core 30 follows a program sequence of instructions indicated by the code 39. Each instruction may enter a front end portion 31 and be processed by one or more decoders 32. The decoder 32 may generate as its output a micro operation such as a fixed width micro operation in a predefined format, or may generate other instructions, microinstructions, or control signals which reflect the original code instruction. The illustrated front end 31 also includes register renaming logic 33 and scheduling logic 34, which generally allocate resources and queue the operation corresponding to the convert instruction for execution.

The processor 30 is shown including execution logic 35 having a set of execution units 35-1 through 35-N. Some embodiments may include a number of execution units dedicated to specific functions or sets of functions. Other embodiments may include only one execution unit or one execution unit that can perform a particular function. The illustrated execution logic 35 performs the operations specified by code instructions.

After completion of execution of the operations specified by the code instructions, back end logic 36 retires the instructions of the code 39. In one embodiment, the processor 30 allows out of order execution but requires in order retirement of instructions. Retirement logic 37 may take a variety of forms as known to those of skill in the art (e.g., re-order buffers or the like). In this manner, the processor core 30 is transformed during execution of the code 39, at least in terms of the output generated by the decoder, the hardware registers and tables utilized by the register renaming logic 33, and any registers (not shown) modified by the execution logic 35.

Although not illustrated in FIG. 9, a processing element may include other elements on chip with the processor core 30. For example, a processing element may include memory control logic along with the processor core 30. The processing element may include I/O control logic and/or may include I/O control logic integrated with memory control logic. The processing element may also include one or more caches.

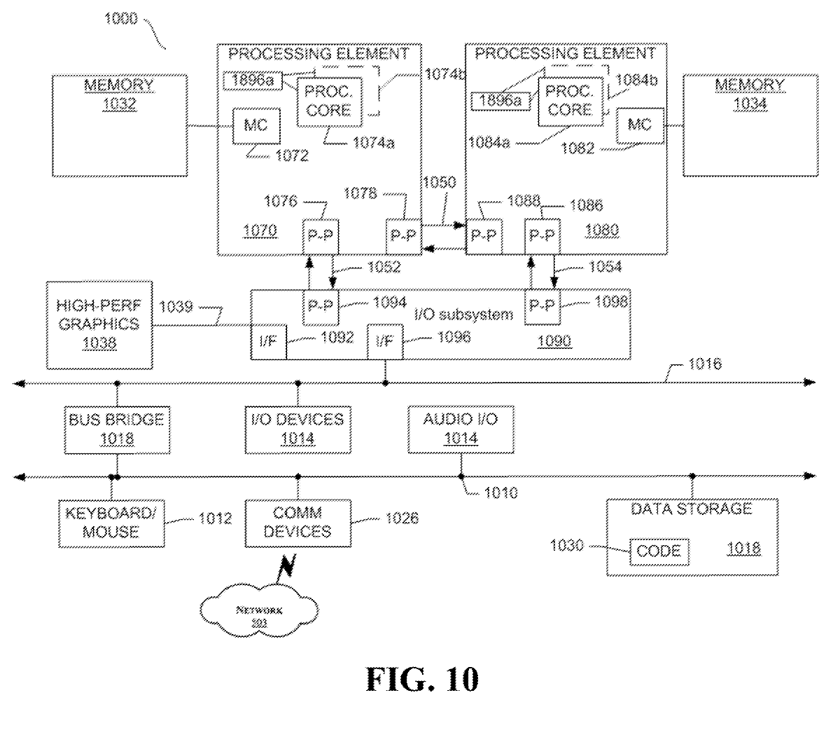

Referring now to FIG. 10, shown is a block diagram of a system embodiment 1000 in accordance with an embodiment of the present invention. Shown in FIG. 10 is a multiprocessor system 1000 that includes a first processing element 1070 and a second processing element 1080. While two processing elements 1070 and 1080 are shown, it is to be understood that an embodiment of system 1000 may also include only one such processing element.

System 1000 is illustrated as a point-to-point interconnect system, wherein the first processing element 1070 and second processing element 1080 are coupled via a point-to-point interconnect 1050. It should be understood that any or all of the interconnects illustrated in FIG. 10 may be implemented as a multi-drop bus rather than point-to-point interconnect.

As shown in FIG. 10, each of processing elements 1070 and 1080 may be multicore processors, including first and second processor cores (i.e., processor cores 1074a and 1074b and processor cores 1084a and 1084b). Such cores 1074, 1074b, 1084a, 1084b may be configured to execute instruction code in a manner similar to that discussed above in connection with FIG. 9.

Each processing element 1070, 1080 may include at least one shared cache 1896. The shared cache 1896a, 1896b may store data (e.g., instructions) that are utilized by one or more components of the processor, such as the cores 1074a, 1074b and 1084a, 1084b, respectively. For example, the shared cache may locally cache data stored in a memory 1032, 1034 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the present invention is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, microarchitectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

First processing element 1070 may further include memory controller logic (MC) 1072 and point-to-point (P-P) interfaces 1076 and 1078. Similarly, second processing element 1080 may include a MC 1082 and P-P interfaces 1086 and 1088. As shown in FIG. 10, MC's 1072 and 1082 couple the processors to respective memories, namely a memory 1032 and a memory 1034, which may be portions of main memory locally attached to the respective processors. While the MC logic 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076, 1086 and 1084, respectively. As shown in FIG. 10, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple graphics engine 1038 to I/O subsystem 1090. Alternately, a point-to-point interconnect 1039 may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the present invention is not so limited.

As shown in FIG. 10, various I/O devices 1014 may be coupled to the first bus 1016, along with a bus bridge 1018 which may couple the first bus 1016 to a second bus 1010. In one embodiment, the second bus 1020 may be a low pin count (LPC) bus. Various devices may be coupled to the second bus 1020 including, for example, a keyboard/mouse 1012, communication device(s) 1026 (which may in turn be in communication with a computer network, 503), and a data storage unit 1018 such as a disk drive or other mass storage device which may include code 1030, in one embodiment. The code 1030 may include instructions for performing embodiments of one or more of the methods described above. Thus, the illustrated code 1030 may implement the logic architecture 50 (FIG. 8) and could be similar to the code 39 (FIG. 9), already discussed. Further, an audio I/O 1024 may be coupled to second bus 1020.

Note that other embodiments are contemplated. For example, instead of the point-to-point architecture of FIG. 10, a system may implement a multi-drop bus or another such communication topology. Also, the elements of FIG. 10 may alternatively be partitioned using more or fewer integrated chips than shown in FIG. 10.

Therefore, in one example, a system includes a vendor computer having a detection module to a detect an inquiry relating to an item offered by a first vendor, an analysis module to analyze the inquiry relating to the item and identify the item, and an inquiry module to inquire if the customer would like a counteroffer relating to the item and obtain a counteroffer code that includes the counteroffer relating to the item.

The system may further include a customer interface station having an interface, a camera to capture a representation of the counteroffer code, a counteroffer code analysis module to analyze a representation of the counteroffer code to extract the counteroffer relating to the item, and a display module to display the counteroffer relating to the item via the interface.

Additionally, the customer interface station may further include a counteroffer modification module to modify the counteroffer relating to the item.

In addition, the system may further include a vendor payment station having a transaction module to conduct a transaction relating to the item based on the counteroffer code, and a message module to output a transaction completion message, wherein the transaction completion message is to include a receipt for the transaction.

In addition, the system may further include a transaction information server having a transaction information module to retrieve information pertaining to one or more transactions relating to the customer.

Additionally, the counteroffer code of the system may be encrypted.

Moreover, the counteroffer code of the system may be one of a quick response (QR) code and a barcode.

Moreover, the counteroffer of the system may be conditionally limited by one or more of time and distance.

In another example, a method includes detecting an inquiry relating to an item offered by a vendor, analyzing the inquiry relating to the item to identify the item, generating a counteroffer relating to the item, generating a counteroffer code including the counteroffer relating to the item, and conducting a transaction relating to the item utilizing the counteroffer code.

Additionally, generating the counteroffer relating to the item may include accessing a product information store.

In addition, generating the counteroffer relating to the item may include accessing customer transaction information.

In addition, generating the counteroffer relating to the item may include accessing price comparisons for the item.

Additionally, the method may further provide for inquiring if the customer would like counteroffer relating to the item.

Moreover, the method may further include capturing a representation of the counteroffer code, and analyzing the representation of the counteroffer code to extract the counteroffer relating to the item.

Moreover, the method may further include displaying the counteroffer relating to the item on an interface.

Additionally, the method may further include generating a second offer relating to the item based on input from the customer.

In addition, the method may further include transmitting a transaction completion message, wherein the transaction completion message is to include a receipt for the transaction.

In addition, the method may further include updating one or more of a customer transaction store and a vendor inventory based on the transaction relating to the item.

Moreover, the method may further include deleting the counteroffer code from a customer device.

Moreover, the counteroffer code of the method may be encrypted.

Additionally, the counteroffer code of the system may be one of a quick response (QR) code and a barcode.

In addition, the counteroffer relating to the item may be conditionally limited by one or more of time and distance in the method.

In another example, at least one computer readable storage medium may include a set of instructions which, if executed by a processor, cause a computer to perform any aspect of the aforementioned method examples.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Techniques described herein may therefore provide a feed-forward system that ensures both real-time operation of the consumer video pipeline and dynamic updating of the operating pipeline to deliver optimal visual perceptual quality and viewing experience. In particular, a discrete control system for the video pipeline can dynamically adapt operating points in order to optimize a global configuration of interactive component modules that are related to video perceptual quality. In a series configuration, the perceptual quality analysis module may be placed before the video processing pipeline and parameters determined for the post-processing pipeline may be used for the same frame. In the case of distributed computation of the quality analysis block or when perceptual quality analysis needs to be performed at intermediate points in the pipeline, the parameters determined using a given frame may be applied on the next frame to ensure real-time operation. Distributed computation is sometimes beneficial in reducing complexity as certain elements for perceptual quality computation may already be computed in the post-processing pipeline and can be re-used. Illustrated approaches may also be compatible with closed-loop control where the perceptual quality analysis is re-used at the output of the video processing pipeline to estimate output quality, which is also used by the control mechanism.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A system comprising:
a vendor computer including:
a detection module to a detect an inquiry relating to an item offered by a first vendor,
an analysis module to analyze the inquiry relating to the item and identify the item, and
an inquiry module to inquire if the customer would like a counteroffer relating to the item and obtain a counteroffer code that includes the counteroffer relating to the item.

2. The system of claim 1, further including:
a customer interface station having,
an interface;
a camera to capture a representation of the counteroffer code;
a counteroffer code analysis module to analyze a representation of the counteroffer code to extract the counteroffer relating to the item; and
a display module to display the counteroffer relating to the item via the interface.

3. The system of claim 2, wherein the customer interface station is to further include a counteroffer modification module to modify the counteroffer relating to the item.

4. The system of claim 1, further including a vendor payment station including:
a transaction module to conduct a transaction relating to the item based on the counteroffer code; and
a message module to output a transaction completion message, wherein the transaction completion message is to include a receipt for the transaction.

5. The system of claim 1, further including a transaction information server including a transaction information module to retrieve information pertaining to one or more transactions relating to the customer.

6. The system of claim 1, wherein the counteroffer code is to be encrypted.

7. The system of claim 1, wherein the counteroffer code is to be one of a quick response (QR) code and a barcode.

8. The system of claim 1, wherein the counteroffer is to be conditionally limited by one or more of time and distance.

9. A method comprising:
detecting an inquiry relating to an item offered by a vendor;
analyzing the inquiry relating to the item to identify the item;
generating a counteroffer relating to the item;
generating a counteroffer code including the counteroffer relating to the item; and
conducting a transaction relating to the item utilizing the counteroffer code.

10. The method of claim 9, wherein generating the counteroffer relating to the item includes accessing a product information store.

11. The method of claim 9, wherein generating the counteroffer relating to the item includes accessing customer transaction information.

12. The method of claim 9, wherein generating the counteroffer relating to the item includes accessing price comparisons for the item.

13. The method of claim 9, further including inquiring if the customer would like counteroffer relating to the item.

14. The method of claim 9, further including:
capturing a representation of the counteroffer code; and
analyzing the representation of the counteroffer code to extract the counteroffer relating to the item.

15. The method of claim 14, further including displaying the counteroffer relating to the item on an interface.

16. The method of claim 9, further including generating a second offer relating to the item based on input from the customer.

17. The method of claim 9, further including transmitting a transaction completion message, wherein the transaction completion message includes a receipt for the transaction.

18. The method of claim 9, further including updating one or more of a customer transaction store and a vendor inventory based on the transaction relating to the item.

19. The method of claim 9, further including deleting the counteroffer code from a customer device.

20. The method of claim 9, wherein the counteroffer code is encrypted.

21. The method of claim 9, wherein the counteroffer code is one of a quick response (QR) code and a barcode.

22. The method of claim 9, wherein the counteroffer relating to the item is conditionally limited by one or more of time and distance.

23. At least one computer readable storage medium comprising a set of instructions which, if executed by a processor, cause a computer to:
detect an inquiry relating to an item offered by a vendor;
analyze the inquiry relating to the item to identify the item;
generate a counteroffer relating to the item;
generate a counteroffer code including the counteroffer relating to the item; and
conduct a transaction relating to the item utilizing the counteroffer code.

26. The at least one computer readable storage medium of claim 23, wherein, if executed, the set of instructions cause a computer to inquire if the customer would like counteroffer relating to the item.

27. The at least one computer readable storage medium of claim 23, wherein, if executed, the set of instructions cause a computer to:
capture a representation of the counteroffer code; and
analyze the representation of the counteroffer code to extract the counteroffer relating to the item.

28. The at least one computer readable storage medium of claim 23, wherein, if executed, the set of instructions cause a computer to display the counteroffer relating to the item on an interface.

29. The at least one computer readable storage medium of claim 23, wherein, if executed, the set of instructions cause a computer to generate a second offer relating to the item based on input from the customer.

30. The at least one computer readable storage medium of claim 23, wherein, if executed, the set of instructions cause a computer to transmit a transaction completion message, wherein the transaction completion message is to include a receipt for the transaction.
